(19) United States
(12) Patent Application Publication
(10) Pub. No.: US 2011/0078043 A1
(43) Pub. Date: Mar. 31, 2011

(54) PAYMENT AND TRANSFER MANAGEMENT SYSTEM USING WIRELESS COMMUNICATION NETWORK OR INTERNET AND METHOD THEREOF

(76) Inventor: Dojin RA, Uiang-si (KR)

(21) Appl. No.: 12/883,249

(22) Filed: Sep. 16, 2010

(30) Foreign Application Priority Data
Sep. 25, 2009 (KR) 10-2009-0090781

(51) Int. Cl. G06Q 20/00; G06Q 30/00

(52) U.S. Cl. 705/26.41; 235/380; 705/44

(57) ABSTRACT

A payment and transfer management system using a wireless communication network or internet and a method thereof are disclosed. The present invention relates to a payment management method for enhancing safety of a payment process by using a location tracking method between a card payment terminal and a payer cellular phone, and more particularly to a payment management method for performing easily a card payment process and an account transfer process between a registered payer and a payment demander by using a VM banking module of a cellular phone. The present invention includes a composition for performing card management, approval, and payment through an owner (manager) cellular phone by requesting an immediate payment, a payment and report, and a payment approval according to the sum set through the cellular phone when the payment process is performed by a card payment terminal separated from a location of an owner (manager) cellular phone.

### BACKGROUND OF THE INVENTION

1. Field of the Invention

The present invention relates to a payment management system including a protocol for processing a financial transaction such as a card payment and an account transfer, etc and a server and each terminal for performing the protocol by using a wireless communication network or an internet.

2. Description of the Related Art

The use of cards including a credit card and a debit card is gradually increased in proportionally to the increment of a card supply, card affiliates, and an economical size. However, the security and the convenience in the use of the cards are not improved in comparison with the increment of the use of the cards. Only a method for preventing the increment of losses due to the loss of cards or the burglaries of cards is to transmit a payment specification message to a cellular phone of a card owner or a card manager after a payment process.

Only a method for controlling a use of a company card of an employee in advance is to perform a payment process after depositing money to an employee account. Accordingly, the company and the employees bear all the losses since the high limit of the company card causes the loss of the company card and a deliberate crime of a third party. The losses of card owners and a card company due to the loss of cards are increased gradually since the card owners and the card company do not recognize the loss of the cards and the uses of the lost cards.

Meanwhile, a conventional virtual machine (VM) banking cellular phone has only a transfer function and a checking function. VM banking users are gradually increased at high speed. However, the VM banking users suffer inconvenience since a VM banking system does not have a card payment function.

A conventional cellular phone payment process is performed by using a cellular phone having a payment function chip. The cellular phone having the payment functional chip is not supplied widely because of high price thereof. In addition, the user of the cellular phone having the payment functional chip suffers inconvenience since banks use different kinds of payment functional chips.

VM banking users are increased according to a development of VM banking for providing the payment function and the checking function without the payment functional chip. However, the VM banking users suffer inconvenience since the VM banking does not provide the card payment function, as described above.

When the user pays utility bills by using the card, the user performs a card payment process by providing a card number, an expiration date, and a resident registration number through a telephone to an opponent (a card payment demander and a utility bill receiver). In the card payment process, the user doubts whether the opponent is the card payment demander (or a card payment receiver) or not. In addition, the card payment process has a lot of danger since the card payment receiver can record and use the important numbers of the user to process the card payment for other purposes.

Hence, the utility bills, maintenance fees, or tuition fees are not paid by a remote card payment manner. The card payment process has a lot of disadvantages since the user processes directly the card payment in front of a card payment terminal.

An internet banking method is proposed as an alternative. At present, the payment method using the internet banking is limited to the account transfer. The Internet banking is not used for the card payment. In addition, the Internet banking causes inconvenience in a use process thereof by inputting a one time password (OTP) or an authentication number in only a corresponding window.

### SUMMARY OF THE INVENTION

An object of the present invention is to provide a card payment management method capable of simplifying a card payment function as well as conventional transfer and checking functions by adding the card payment function to a VM banking module and downloading the VM banking module having the added function.

An object of the present invention is to enhance the security and convenience of the card payment by confirming a payment specification received through an SMS and an MMS and transmitting an authentication number through the cellular phone instead of performing a payment process using a card number and a resident registration number in the remote place and to seek security and convenience the location tracking and comparison between the cellular phone and the card payment terminal.

In addition, a composition for adding a payment function to the VM banking system downloaded and installed in the cellular phone can perform easily a card payment process by using a card payment system of a bank or a credit card company without an additional payment system of a card payment part (a card payment receiver, a card payment demander). For example, the card payment process can be performed easily through a cellular phone of a delivery man. In addition, Home shopping's payments, Internet shopping's payments, Mobile shopping payments, the tuition fees, the utility bills, and the maintenance fees can be paid easily through a receiving and transmitting payment using a VM banking cellular phone having a payment function in the remote place.

### BRIEF DESCRIPTION OF THE DRAWINGS

FIG. 1 is a diagram illustrating an entire structure of a card payment management system according to an exemplary embodiment of the present invention.

FIG. 2(a) is a diagram illustrating a transfer process of a conventional VM banking system.

FIG. 2(b) is a diagram illustrating a payment process of a VM banking system according to an exemplary embodiment of the present invention.

FIG. 3 is a diagram illustrating a payment management system using a VM banking module according to an exemplary embodiment of the present invention.

FIG. 4 is a diagram illustrating a payment and payment management system for connecting a payment receiver to a financial payment server of a bank or a card company according to another exemplary embodiment of the present invention.

FIG. 5 is a diagram illustrating a payment and payment management system for searching a product by using a cellular phone according to another exemplary embodiment of the present invention.

FIG. 6 is a diagram illustrating a payment and payment management system for performing a payment approval for internet shopping by using a VM banking module according to another exemplary embodiment of the present invention.

FIG. 7 is an operational flowchart illustrating a process for registering information of a card owner to a payment system in the system of FIG. 1.

FIG. 8 is an operational flowchart illustrating a payment process of a card in the system of FIG. 1.

FIG. 9 is an operational flowchart illustrating a payer receiving payment process in a state of installation of a VM banking module according to another exemplary embodiment of the present invention.

FIG. 10 is an operational flowchart illustrating a payer transmitting payment process in a state of installation of a VM banking module according to another exemplary embodiment of the present invention.

FIG. 11 is an operational flowchart illustrating a VM banking payment process in a stetting state of an expiration date or a limit of a card according to another exemplary embodiment of the present invention.

FIG. 12 is an operational flow chart illustrating a payment process using a cellular phone in the exemplary embodiment of FIG. 4.

FIG. 13 is an operational flowchart illustrating a search and shopping payment process using a cellular phone in the exemplary embodiment of FIG. 5.

FIG. 14 is an operational flowchart illustrating a search and shopping payment process using a cellular phone in the exemplary embodiment of FIG. 6.

FIG. 15 is an operational flowchart illustrating a payment approval process using a cellular phone in an internet banking process according to another exemplary embodiment of the present invention.

### DETAILED DESCRIPTION OF THE EMBODIMENTS

In the following detailed description, only certain exemplary embodiments of the present invention have been shown and described, simply by way of illustration.

As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

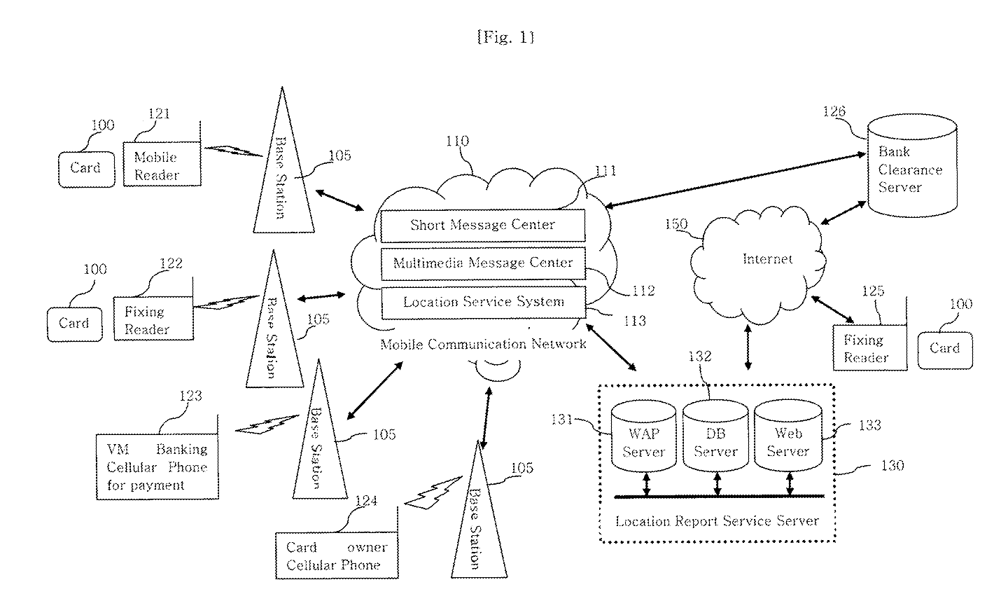

FIG. 1 is a diagram illustrating an entire structure of a card payment management system according to an exemplary embodiment of the present invention.

A short message service center (SMSC) 111 and a multimedia message service center (MMSC) 112 within a mobile communication network 110 perform a role for transmitting payment information to a cellular phone 124 of a payer.

In addition, the mobile communication network 110 provides a data service network as well as a voice service. An IS-95A network (14.4 Kbps), an IS-95B network (64 Kbps), an IS-95C network (144 Kbps), a 1X EV-DO (HDR), and etc. are used currently for a data communication service to be transmitted through a WAP gateway 131.

A location tracking system 113 within the mobile communication network 110 performs a function for tracking a location of the cellular phone 124 of the payer.

When a payment demander (payment receiver) performs a payment process by a contact or an access between an own card of the payer or a card 100 under control of the payer and a mobile terminal 121 or a first fixing terminal 122, the location tracking system 113 tracks locations of the terminals 121, 122 as paying targets to be tracked and the location of the cellular phone 124 of the card owner (manager). A predetermined payment management sequence is started when the distance between the tracked locations is identified as the predetermined distance apart from each other.

At this time, a location of the first fixing terminal 122 can be detected according to location information recorded previously in a terminal information table without using the mobile communication network 110.

Meanwhile, when the payment demander registers his cellular phone as a payment cellular phone 123 and transmits a payment request to the mobile communication network 110 by using the payment cellular phone 123, the location tracking system 113 can detect the location of the payment cellular phone 123 by using a base station 105.

However, when the locations of the cellular phone 123 of the payer, the payment cellular phone 123, and the mobile terminal 121 are tracked by using the base station 105, an object of the present invention for preventing an illegal payment due to burglary and loss can be not occasionally obtained by a wide covering region of the base station. Accordingly, the location tracking system 113 can detect the location of each of payers by using additionally a global positioning system (GPS) except for the base station 105.

The payment request transferred to the mobile communication network 110 is transmitted to a financial payment server 126.

The financial payment server 126 tracks the present location of the cellular phone 124 of the payer and performs a payment process according to a location relation when receiving the payment request, a corresponding payment sum, and information of a payment specification from the payment demander.

When the location of the cellular phone 124 of the payer is not remotely separated from the locations of the terminals 121, 122 or the location of the payment cellular phone 123, the financial payment server 126 approves the payment of the corresponding payment sum by confirming a safe state.

When the location of the cellular phone 124 of the payer is remotely separated from the locations of the terminals 121, 122 or the location of the payment cellular phone 123, a small sum is immediately paid according to the amount of the corresponding payment sum. An intermediate sum is paid and the payment process (payment sum, payment specification, and information of payment demander) is simultaneously reported to the cellular phone 124 of the payer through SMS/MMS. In case of the corresponding payment sum corresponding to a large sum, the SMS or the MMS for requesting the approval to the cellular phone 124 of the payer can be transmitted. When the payer transmits a correct confirmation number through the cellular phone 124, the corresponding payment sum is paid.

A location report service server 130 includes a wireless application protocol (WAP) server 131 for providing a wireless internet service through the mobile communication network 110, a DB server 132 for storing data, and a web server 133 for providing a web page through wire internet. The DB server 132 can be connected to the financial payment server 126 through the mobile communication network 110 and can be directly to the financial payment server 126 by using an internet 150 or a local area network (LAN).

When the card 100 come in contact with or accesses a second fixing terminal 125 in order to perform the payment process, a similar process is performed through the internet 150. The second fixing terminal 125 transmits the payment request, the payment specification, and the corresponding payment sum to the financial payment server 126. The financial payment server 126 detects the location of the cellular phone 124 and grasps a distance from the second fixing terminal 125 by the help of the location tracking system 113 of the mobile communication network 110.

At this time, the mobile communication network 113 can report only the compared result between the location of the cellular phone 124 and the locations of other terminals 121, 122, 125 or the location of the payment cellular phone 123 instead of reporting the location of the cellular phone 124 in detail to the financial payment server 126 since the operation of the financial payment server 126 for detecting the location of the cellular phone 124 in detail causes invasion of privacy.

The payer of the card 100 accesses the financial payment server 126 through the internet 150 or the mobile communication network 110 and inputs information about the cellular phone 124 and the own card 100 into the financial payment server 126. The financial payment server 126 stores the information about the cellular phone 124 and the card 100 into the DB server 132.

The payment demander (receiver) inputs the payment cellular phone 123 as a cellular phone or the terminals 121, 122, 125 as well as his businessman information into the financial payment server 126. The financial payment server 126 stores information about payment demanders into an additional table region within the DB server 132.

In order to provide a service according to the present invention, the mobile terminal 121 receives a unique subscriber number (telephone number or ID) from a mobile communication network provider to use the mobile communication network 110. The mobile terminal 121 is registered with the database server 132 of the location report service server 130. In other words, items of a terminal ID, a kind of the terminal, an installation location, a position, a location, and etc. are stored in the database server 132. A telephone number of the mobile communication network 110 can be used as an ID of the mobile terminal 121.

In case of the first fixing terminal 122, location information including an address of the installation location is stored into the database server 132.

The mobile terminal 121 transfers data including an ID of the card 100, the ID of the mobile terminal 121, the corresponding payment sum, and a card payment date to the location report service server 130 through the mobile communication network 110 by reading the data recorded in the card 100.

The location report service server 130 analyzes received packets, confirms whether the card owner is the service subscriber by searching and analyzing a subscriber (payer) information table of the database server 132 with the ID of the card 100, and collects the information about the terminals 121, 122, 125 by searching a terminal information table with the ID of the terminals 121, 122, 125.

When the location report service server 130 generates a message and transmits a request to the mobile communication network 110 in order to transmit the message to the cellular phone 124 of the card owner, the SMSC 111 or the MMSC 112 of the mobile communication network 110 transfers the received message to the cellular phone 124 and performs a payment report or a payment approval request.

The card owner or manager receives the payment report or the payment approval request and can grasp a state of loss and a present location if the card 100 is lost. The card owner or manager can confirm a specification of a company card since the manager can grasp the amount of the company card spent by an employee. The card owner or manager can manage safely the company card since the manager approves the payment of the large sum through the cellular phone 124.

Here, the card 100 can include a golf membership, a bond, a certificate of deposit, or various stocks as well as a credit card. The card can include all kinds of exchange values and payment units.

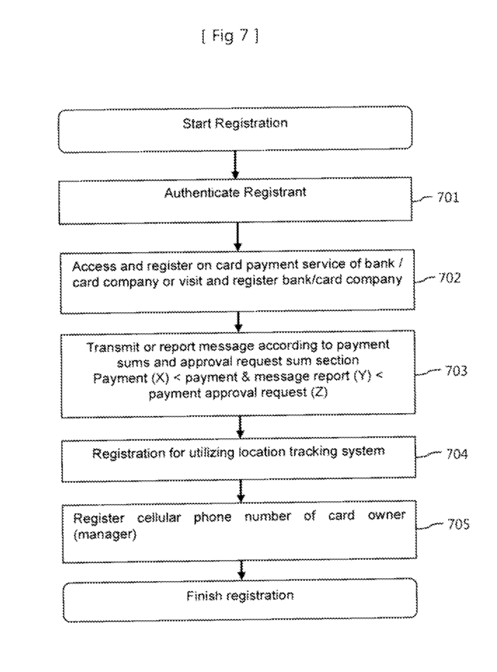

FIG. 7 is an operational flowchart illustrating a process for registering the information of a card owner to a payment system in the system of FIG. 1.

The card owner or manager, as a registrant accesses and registers a payment service of a bank or a card company through a certification process S701. At this time, the technical spirit and scope of the present invention is characterized in that the registrant accesses the payment service of the bank or the card company through the internet 150 or the mobile communication network 110. However, it is an axiomatic fact in an expert group that a direct visit and registration to the bank or the card company to avoid the appended claims of the present invention belongs to an equal scope of rights of the present invention.

The registrant sets a simple payment section, a payment reporting section, and a payment approval request section according to the corresponding payment sum S703.

The corresponding payment sum corresponding to the small sum (below a first reference sum) is set as the simple payment section X. The corresponding payment sum corresponding to the intermediate sum (more than the first reference sum and below a second reference sum) is set as a message reporting section Y posterior to the payment. The corresponding payment sum corresponding to the large sum (more than the second reference sum) is set as the payment approval request section Z.

The registrant performs a registering process for utilizing the location tracking system in order to track the location of the cellular phone 124 S704. The cellular phone number is inputted to track the location of the cellular phone S705.

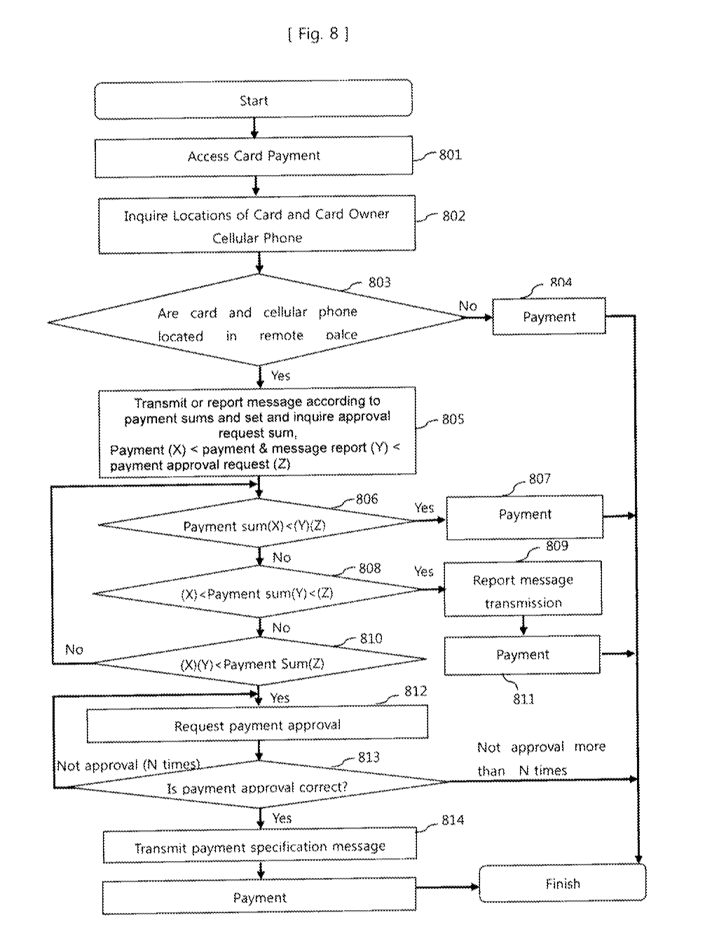

FIG. 8 is an operational flowchart illustrating a payment process of the card 100 in the system of FIG. 1

The card 100 comes in contact with or accesses the terminals 121, 122, 125 or the cellular phone 123 so that the terminals 121, 122, 125 or the cellular phone 123 access the financial payment server 2 to pay the corresponding payment sum S801.

The location of the card 100 is detected from the locations of the terminals 121, 122, 125 or the location of the cellular phone 124 and the location of the cellular phone 124 are tracked S802.

It is determined whether the location of the card 100 is remotely separated from the location of the cellular phone 124 S803. The corresponding payment sum is paid if the location of the card 100 is not remotely separated from the location of the cellular phone 124 S804.

The reference sums (the first reference sum, the second reference sum) of the predetermined sections X, Y, Z are requested if the location of the card 100 is remotely separated from the location of the cellular phone 124 S805.

The corresponding payment sum is paid S807 if the corresponding payment sum belongs to the X section S806.

The transmission of the message related to the payment specification is reported to the mobile communication network 110 S809 if the corresponding payment sum belongs to the Y section S808. The corresponding payment sum is paid after the transmission of the message related to the payment specification is reported S811.

The payment approval is requested to the cellular phone 124 S812 if the corresponding payment sum belongs to the Z section S810. At this time, the prior steps S806, S808, S810 are performed again when the section of the corresponding payment sum is incorrectly determined.

The financial payment server 126 determines whether the confirmation number received from the cellular phone 124 corresponds to the stored confirmation number S813.

The financial payment server 126 pays the corresponding payment sum and requests transmission of a message for the payment specification to the mobile communication network 110 if the confirmation number received from the cellular phone 124 corresponds to the stored confirmation number S814.

The steps S812, S813 are repeatedly performed N times if the confirmation number received from the cellular phone 124 does not correspond to the stored confirmation number.

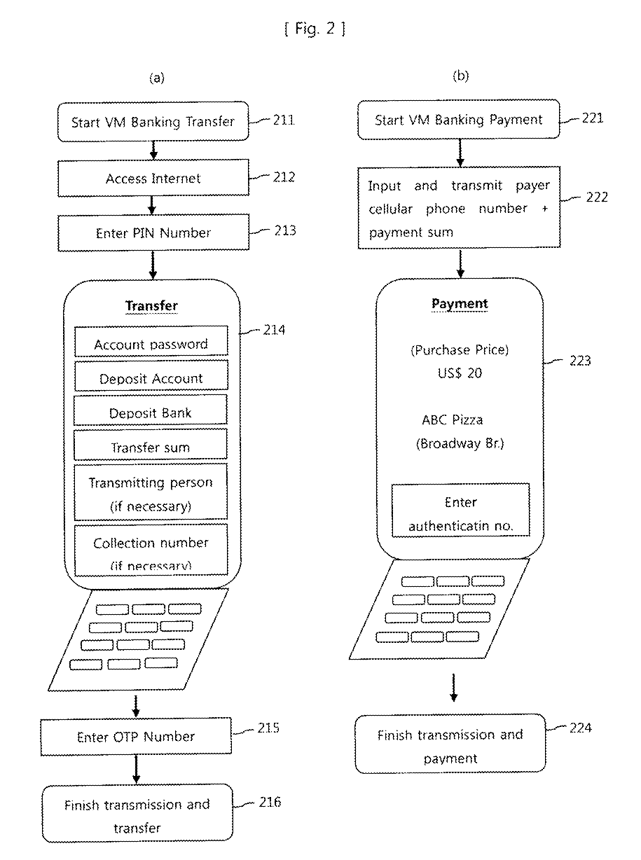

FIG. 2(a) is a diagram illustrating a transfer process of a conventional VM banking system.

The conventional VM banking system starts a transfer process S211 by performing a login to a VM banking transfer process, performs an Internet access process S212, inputs a PIN number S213 to prepare the transfer process. The conventional VM banking system records an account password, an account for deposit, a bank for deposit, a transfer sum, a remitter, a depositor as the needs arises in order to perform the account transfer S214.

An OTP is inputted by using an additional terminal or cellular phone S216. The transfer information is transmitted and the transfer process is finished S216. The transfer process is completed if the OTP is correct.

The transfer process like this is not obviously seen to the payer since the bank for deposit is systematized. However, the transfer process is transferred to the system like a payment request message of the cellular phone or performs automatically the payment process from the DB of the payer to the DB of the payment receiver according to the payment unit selected from the credit card, the debit card, and the mileage card when the payment is approved to the cellular phone of the payer after a waiting state on the financial payment server with respect to the payer. The transfer process like this has a problem due to a complex procedure since the payer inputs the large amount of information.

FIG. 2(b) is a diagram illustrating a payment process of a VM banking system according to an exemplary embodiment of the present invention.

The VM banking system has an additional function capable of performing the payment process as well as the transfer process. A start process for the payment process is performed through the VM banking module S221.

The payment demander inputs the cellular phone number of the payer and the payment sum and transmits the cellular phone number of the payer and the payment sum to the financial payment server 126 S222.

As described in FIG. 2, an exemplary embodiment is displayed on a screen of the cellular phone of the payer. An input window for inputting the corresponding payment sum, the information of the payment demander, and an authentication number is displayed on the screen of the cellular phone 124. Here, the authentication number can be the number which is registered previously by the payer in a registration process of FIG. 7.

The payer inputs and transmits the authentication number onto the screen of the cellular phone 124. The financial payment server 126 determines whether the authentication number corresponds to the previously registered number, or not. The financial payment server 126 pays the corresponding payment sum and finishes the process if the authentication number corresponds to the previously registered number.

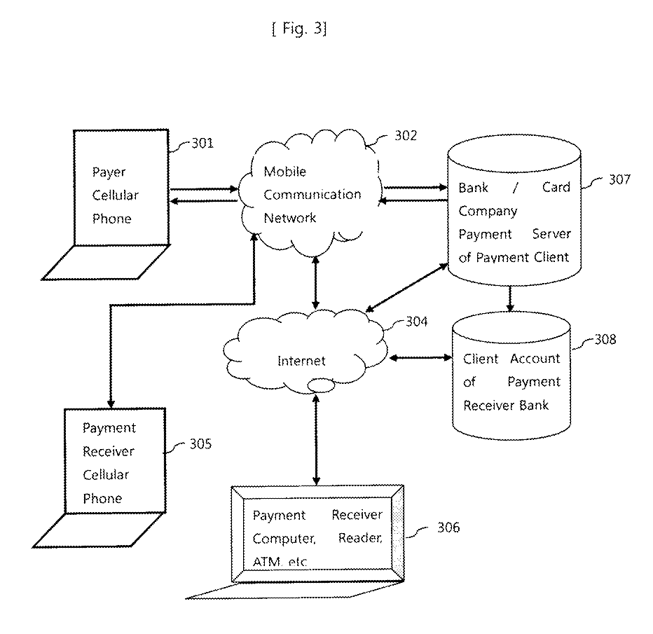

FIG. 3 is a diagram illustrating a payment management system using a VM banking module according to an exemplary embodiment of the present invention.

A payer cellular phone 301 is connected to a financial payment server 307 of bank/card company of a payment client through a mobile communication network 302. A payment receiver (business owner) cellular phone 305 is connected to the financial payment server 307 through the mobile communication network 302. A computer or a terminal 306 of the payment receiver can be connected to the financial payment server 307 through an internet 304. A client account 308 of a bank of the financial payment server is connected directly to the financial payment server 307 or is connected to the financial payment server 307 through the internet 304.

The payment receiver inputs a cellular phone number and a payment sum of the cellular phone 301 of the payer (client) and requests the payment by using the terminal 306 or the cellular phone 305 of the payment receiver (business owner) s222. The corresponding payment sum, the payment request businessman information, and the payment specification like the cellular phone screen 223 of the payer (client) are displayed on the screen. An input menu of the authentication number for the payment is provided.

The payer inputs the confirmation number. The financial payment server 307 confirms the confirmation number. The payment process S224 is finished by transferring the corresponding payment sum from the financial payment server 307 of the client to the client account 308 if the confirmation number corresponds to the stored confirmation number.

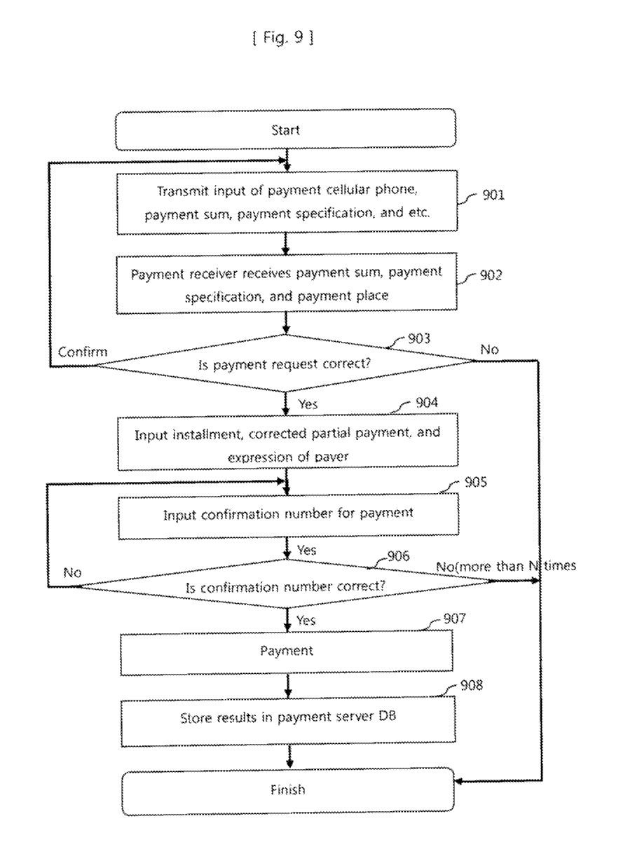

FIG. 9 is an operational flowchart illustrating a receiving payment process of the payer cellular phone 301 in a state of installation of the VM banking module according to another exemplary embodiment of the present invention.

The payment receiver inputs the cellular phone number, the corresponding payment sum, and the payment specification of the payer and transmits the cellular phone number, the corresponding payment sum, and the payment specification of the payer to the financial payment server 307 S901.

The corresponding payment sum, the payment specification, and the information of the payment receiver are displayed on the payer cellular phone 301 S902.

The payer cellular phone 301 confirms whether the payment request is correct S903. At this time, the correctness of the payment request means that the corresponding payment sum, the payment specification, and the information of the payment receiver are equal to the displayed information.

The payer cellular phone 301 receives an installment, a corrected partial payment (a prior payment of a part of total sum), and an expression of the payer S904.

The payer cellular phone 301 receives the confirmation number for the payment from the payer S905.

The financial payment server 307 determines whether the inputted confirmation number corresponds to the registered confirmation number, or not S906.

Here, chances of N number are provided if the inputted confirmation number does not correspond to the registered confirmation number. The authentication process is finished of the payer does not propose the registered confirmation number during the chances of N number.

The financial payment server 307 pays the corresponding payment sum if the inputted confirmation number corresponds to the registered confirmation number according to the determined result S907. The financial payment server 307 stores the paid result to the DB of the financial payment server 307 S908.

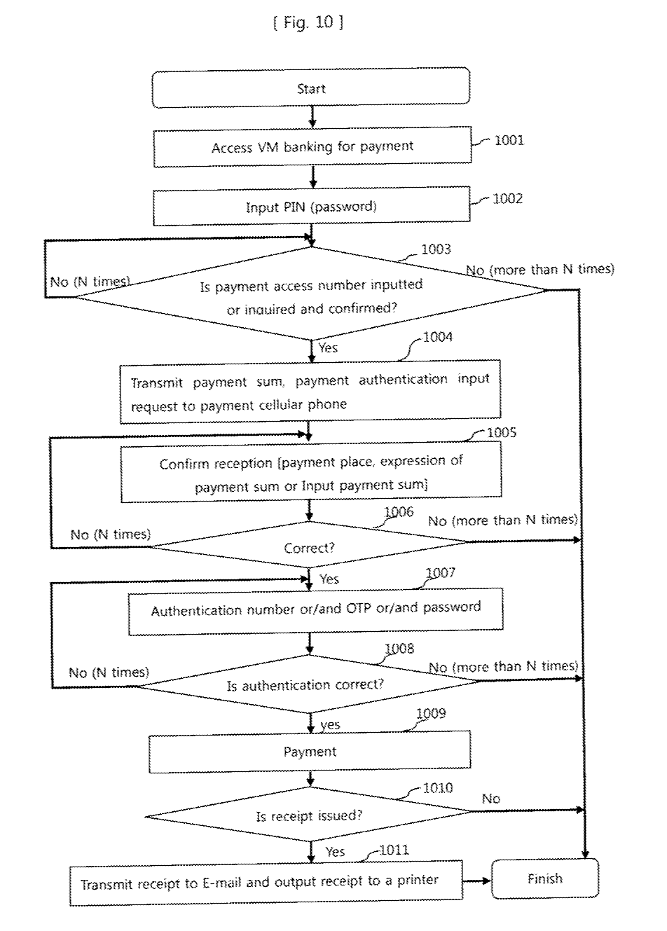

FIG. 10 is an operational flowchart illustrating a transmitting payment process of a payer in a state of installation of a VM banking module according to another exemplary embodiment of the present invention.

The payment method using the payer cellular phone 301 of the payment client having the VM banking module through the internet is similar to the process of FIG. 9. The payer accesses the internet by using the VM banking module for the payment S1001.

The payer inputs a PIN number into the payer cellular phone 301 S1002. The payer inputs or inquires/searches an access number (for example, #1234*+access) of the payment target (payment receiver) S1003. At this time, the step S1003 can be repeatedly performed N times if there is not the correct inquiring target.

The payment demander inputs the information of the payment receiver (businessman) and the corresponding payment sum into the cellular phone or the terminals 305, 306 and transmits the information of the payment receiver (businessman) and the corresponding payment sum to the payer cellular phone 301 S1004. The payer cellular phone 301 receives the corresponding payment sum, the payment specification, and the payment approval request S1005. The payer confirms whether the payment specification displayed on the cellular phone 301 is correct, or not S1006. The payer inputs the authentication number or the authentication number and the OTP according to an input request of the authentication number S1007.

The financial payment server 307 determines whether the authentication number inputted in the step S1007 or the OTP of the authentication number is correct S1008. The financial payment server 307 pays the corresponding payment sum if the authentication number is correct S1009.

Next, the payer requests additionally issuance of a receipt S1010. The receipt is transmitted through an E-mail or a printer S1011. The receipt is issued and the payment process is finished.

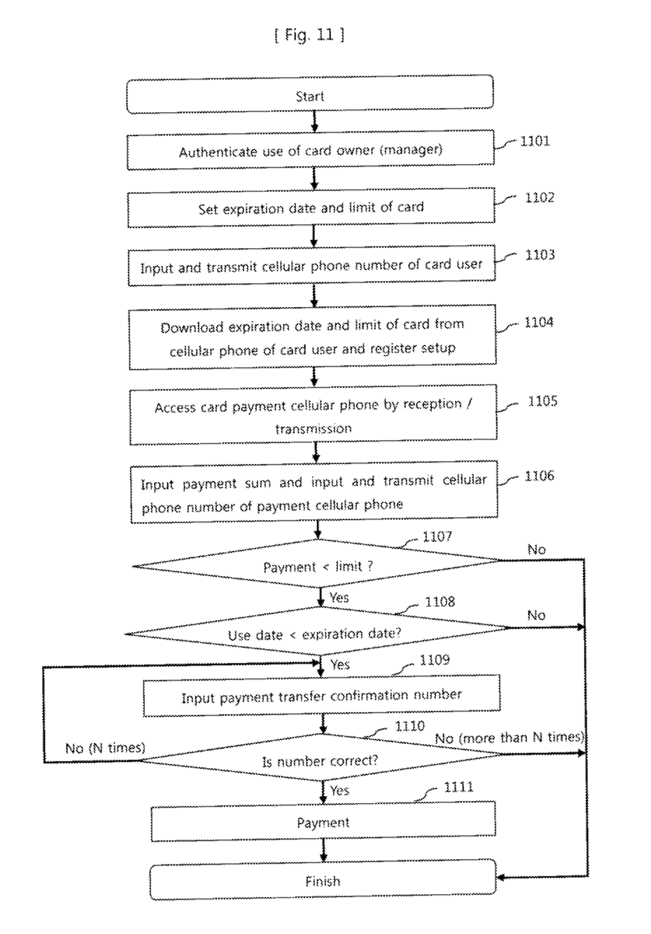

FIG. 11 is an operational flowchart illustrating a VM banking payment process according to another exemplary embodiment of the present invention. The FIG. 11 shows a setting state of an expiration date and a limit of a card.

The card owner (manager) accesses the financial payment server 307 in order to perform a user authentication process by using the payer cellular phone 301 S1101.

The card owner or manager sets the expiration date and the limit of the card S1102.

The card owner or manager sets a use of a permissible card target, namely the employee in case of the company card or permissible ranges of children using cards of parents by limiting the cards of the parents. The card owner or manager inputs a cellular phone number of a card user and transmits the cellular phone number of the card user to a payment server 307 S1103.

A file including the expiration date and the limit of the card transmitted to the cellular phone of the card user is downloaded into and set and registered in the cellular phone of the card user S1104. A connection process is performed by using the cellular phone including the VM banking module having the card payment function S1105.

The corresponding payment sum and the cellular phone number of the payment cellular phone are inputted through the cellular phone of the user S1106. The financial payment server 307 determines whether the corresponding payment sum is more or less than the limit S1107. The financial payment server 307 determines whether the present date is within the expiration date S1108. The financial payment server 307 requests the input of the confirmation number.

The payment server 307 determines whether the confirmation number inputted into the cellular phone of the user corresponds to the registered confirmation number S1110. The financial payment server 307 provides the chances of N number if the confirmation number does not correspond to the registered confirmation number. The financial payment server 307 pays the corresponding payment sum if the confirmation number corresponds to the registered confirmation number S1111.

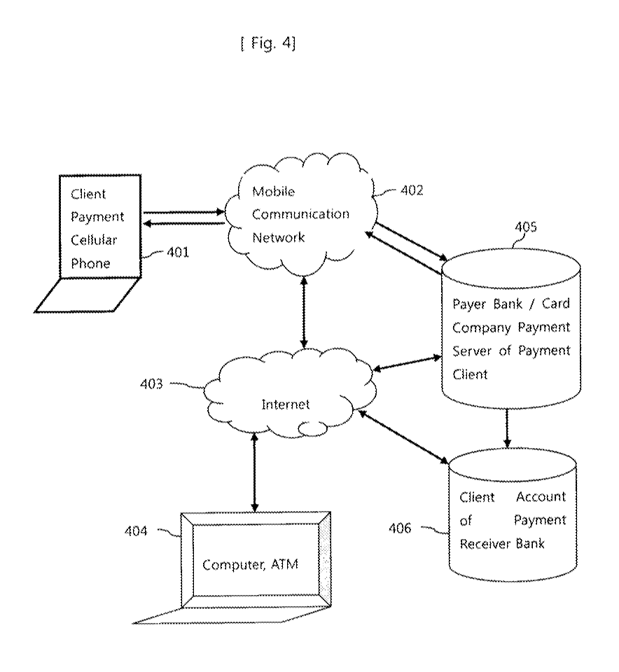

FIG. 4 is a diagram illustrating a payment and payment management system for connecting a payment receiver to a payment server of a bank or a card company according to another exemplary embodiment of the present invention.

A terminal 404 such as a computer of the payment receiver is connected to a payment server 405 through an internet 403. A bank account 406 of the payment receiver is directly connected to the payment server 405 or is connected to the payment server 405 through the internet 403.

The terminal of the payment receiver like this is connected directly or indirectly to the payment server 405 of the bank or the company card. A cellular phone 401 of a client (payer) is connected to the payment server 405 through a mobile communication network 402 in order to perform easily a payment process for the terminal 404. Particularly, when the payment receiver is a utility bill or a maintenance receiver, the payer is connected to the payment server 405 through the cellular phone 401 in order to perform the payment process for the payment receiver.

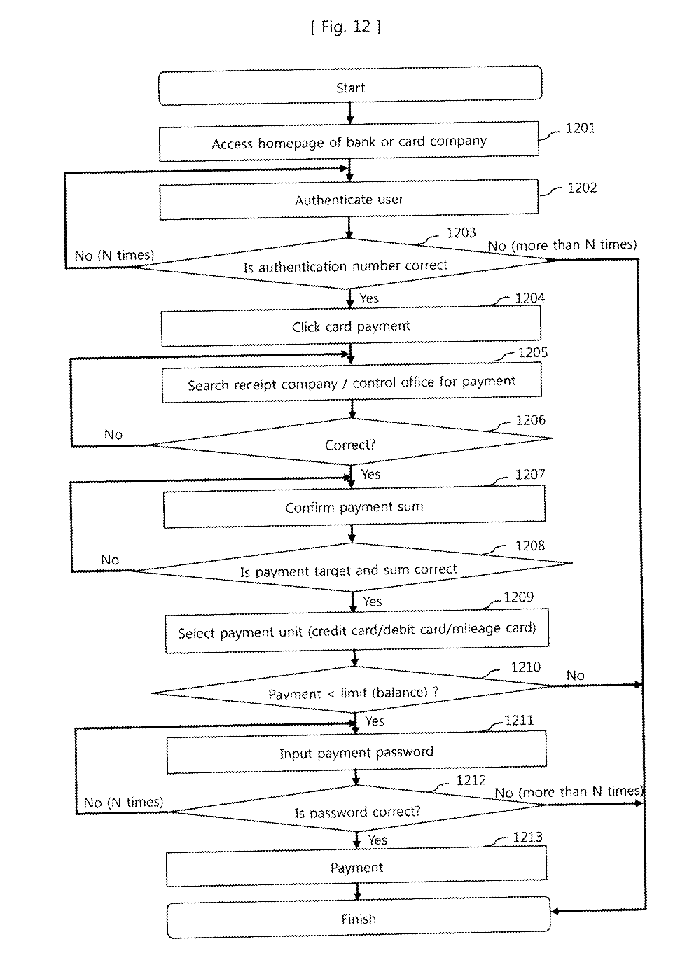

FIG. 12 is an operational flow chart illustrating the payment process using the cellular phone in the exemplary embodiment of FIG. 4.

The payer accesses a homepage of the bank or the card company by using the cellular phone 401 S1201. The payer performs a user authentication process S1202.

When the user authentication is successful S1203, a menu for selecting the card payment is provided. The payer selects the card payment menu S1204.

The payer searches the payment demander from the database of the payment server 405 S1205. When the payer detects the desired payment demander S1206, the payer confirms the corresponding payment sum S1207, S1208 and selects the payment unit S1209. When the payer selects previously all of the usable credit card, debit card, and mileage card, the menu for selecting the payment unit is provided. When the payer selects previously one of the usable credit card, debit card, and mileage card, the menu for selecting the payment unit can be omitted.

When the corresponding payment sum is less than the limit S1210, the payer inputs a password for payment into the cellular phone 401. The payment server 405 pays the corresponding payment sum if the inputted password corresponds to the registered password S1212, S1213.

For example, a method for paying the utility bill and the maintenance through the cellular phone or the internet includes the steps of accessing the internet by inputting a payment access number (for example, #1004*+input) reported through the utility bill into the cellular phone including the VM banking module having the payment function, and identifying automatically the payer by inputting a membership number (client management number) or using the registered cellular phone number for the payment.

The payer confirms a message including the corresponding payment sum and a payment registrant name. The payer inputs the number corresponding to the authentication request if the payment specification is correct.

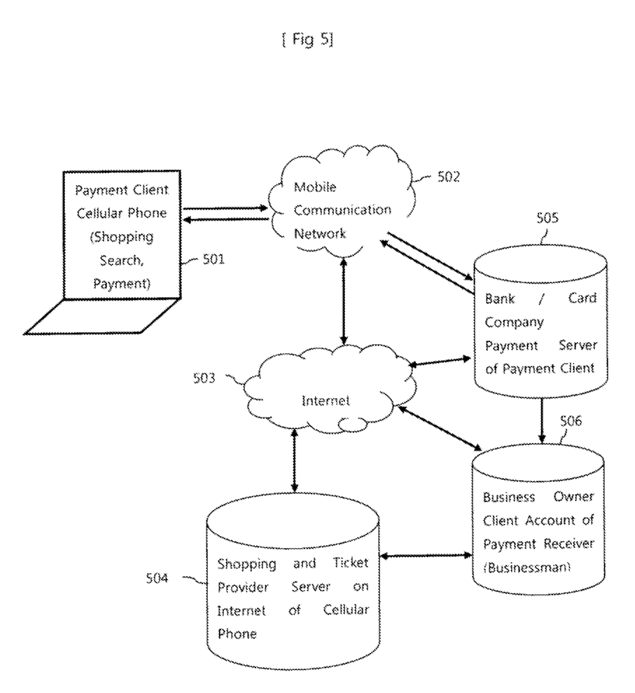

FIG. 5 is a diagram illustrating a payment and payment management system for searching a product by using a cellular phone according to another exemplary embodiment of the present invention.

A payment client (payer) accesses an internet 503 through a cellular phone 501 and a mobile communication network 502. The payment client (payer) accesses an internet shopping mall 504 in order to search a desired product.

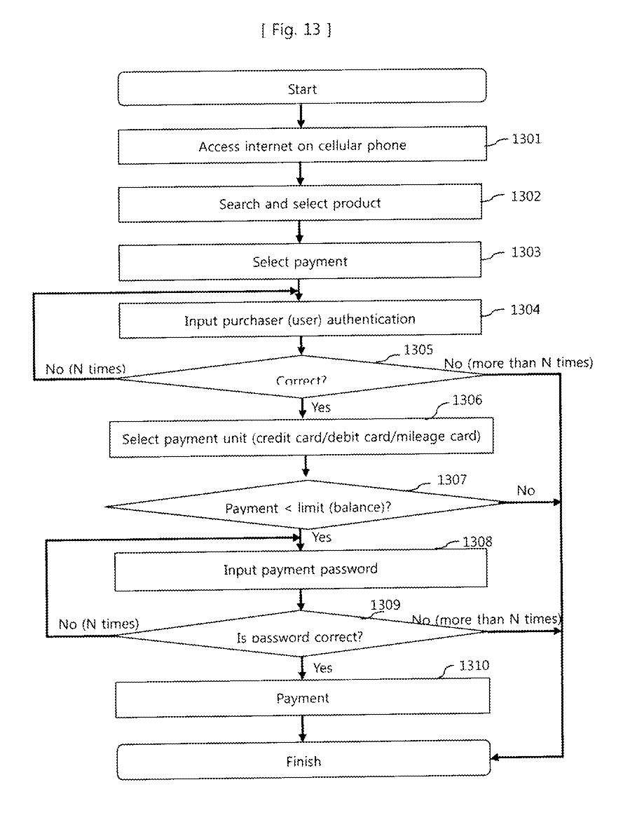

FIG. 13 is an operational flowchart illustrating a search and shopping payment process using a cellular phone in the exemplary embodiment of FIG. 5.

A cellular phone 501 includes the VM banking module having the payment function. It is assumes that the VM banking module has an internet access function.

The payer accesses the internet 503 by using the cellular phone 501 S1301. The payer accesses a site 504 such as a shopping mall site in order to search and select a desired product S1302.

When the payer selects the payment in the corresponding site 504 S1303, a payment server 505 requests the authentication of the purchaser (user) to the cellular phone 501 S1304. When the authentication is successful S1305, the payment server provides a menu for selecting a payment unit to the payer S1306. At this time, if the payer sets previously selection of only one payment unit, the step 1306 can be omitted.

When the corresponding payment sum is less than the limit S1307, the payment server requests an input of a password to the payer S1308. When the inputted password corresponds to the registered password S1309, a payment server 505 pays the corresponding payment sum S1310. The payer designates a delivery destination and reports the delivery destination to the payment server 505. Accordingly, the payment process and the deliver process can be performed at the same time.

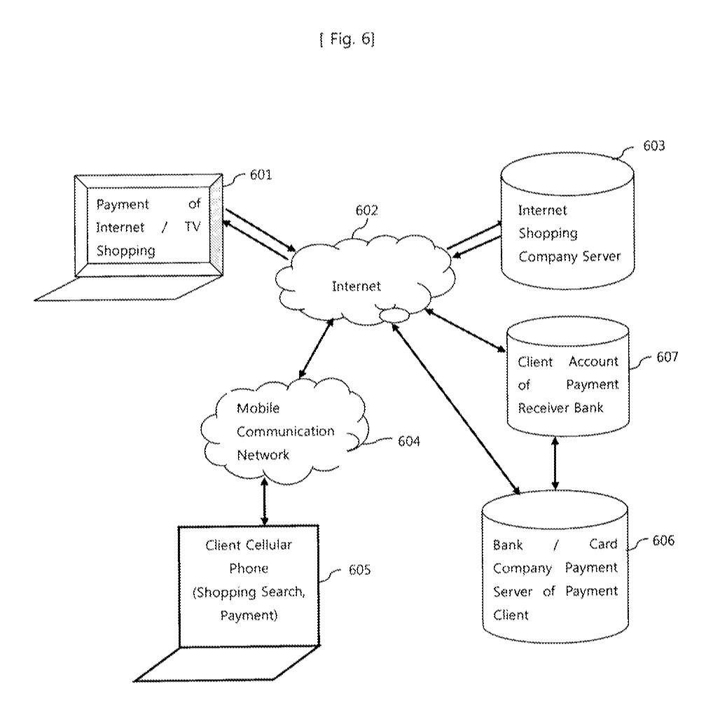

FIG. 6 is a diagram illustrating a payment and payment management system for performing a payment approval for internet shopping by using a VM banking module according to another exemplary embodiment of the present invention.

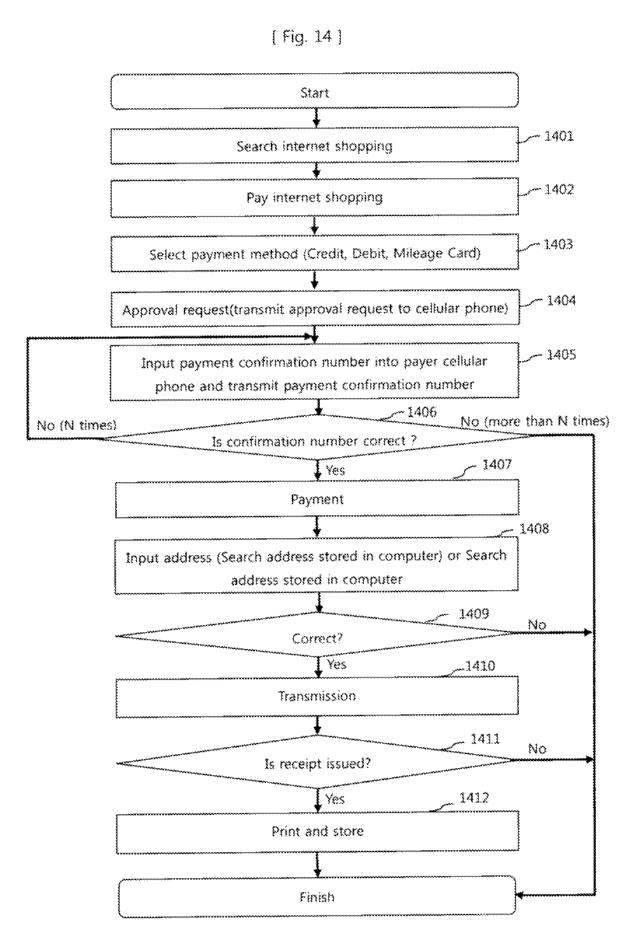

FIG. 14 is an operational flowchart illustrating a search and shopping payment process using a cellular phone in the exemplary embodiment of FIG. 6.

Referring to FIG. 6 and FIG. 14, the payer accesses an internet 602 through a mobile communication network 604 by using a cellular phone 605. The payer searches a product in an internet shipping server 603 S1401.

When the payer selects the payment for the corresponding payment sum of the searched product S1402, an internet shopping payment server 601 can request the payment.

A menu for selecting the payment unit is provided for the cellular phone 605 S1403. The payer selects the payment unit and a payment server 606 requests a payment approval to the cellular phone 605.

The payer inputs a payment confirmation number into the cellular phone 605 and transmits the payment confirmation number S1405. The payment server 606 confirms whether the payment confirmation number corresponds to the registered payment confirmation number S1406.

The payment server 606 pays the corresponding payment sum if the payment confirmation number corresponds to the registered payment confirmation number S1407. The payer inputs and confirms an address of the delivery destination S1408, S1409. The paid product is transmitted to the delivery destination S1410.

When the payer requests an output of a receipt S1411, the receipt is outputted to the payer S1412.

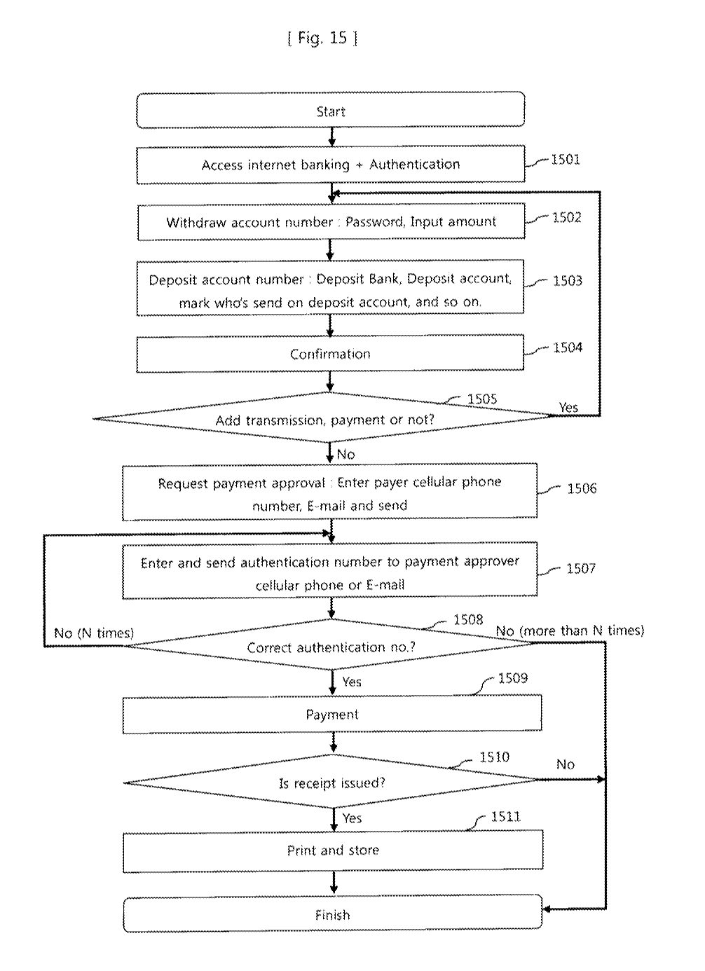

FIG. 15 is an operational flowchart illustrating a payment approval process using a cellular phone in an internet banking process according to another exemplary embodiment of the present invention.

The payer accesses the internet banking by using the cellular phone and performs a user authentication process S1501.

The payer inputs withdrawal account information (including a password and a deposit) by using the cellular phone S1502. The payer inputs deposit account information (a deposit bank, a deposit account number, a message of a receiving bankbook, and etc.) S1503. The payer confirms the inputted information S1504.

When an additional transfer or an additional payment process is not generated S1505, the cellular phone of the payer receives the information such as the cellular phone number and the E-mail of the payer from the payer and transmits the information and the payment approval request to the server S1506.

The server transmits a message for requesting the input of the cellular phone or the E-mail of the payer. The payer inputs the confirmation number into ic the cellular phone or the E-mail S1507.

When the inputted confirmation number corresponds to the registered confirmation number S1508, the payment server pays the corresponding payment sum S1509.

When the payer request the issue of the receipt S1510, the receipt is printed or stored S1511 and the payment process is finished.

The payment management method according to the exemplary embodiment of the present invention is embodied as a type of program commands performed through various computer units in order to be recorded in a computer readable medium. For example, the payment management method can be embodied as a type of VM function module downloaded and installed in the cellular phone or a type of management software installed in a server of a financial system. The payment management method can be provided as a type of software/firmware programmed previously in a memory of the payment terminal and can be performed in programmed orders.

The computer readable medium can include one of a program command, a data file, and a data structure or a combination of the program command, the data file, and the data structure. The program command recorded in the medium is a particular kind designed and composed for the present invention or a usable kind disclosed in a computer software expert group. For example, the computer readable medium is a magnetic medium such as a hard disk, a floppy disk, and a magnetic tape or an optical medium such as a CD-ROM and a DVD or a magneto-optical medium such as a floptical disk or a hardware device such as a ROM, a RAM, and a flash memory which is composed particularly to store and perform the program command. For example, the program command includes a high level language code executed by a computer using an interpreter as well as a machine language code made by a complier. The hardware device can be composed as one or more software module in order to perform operations of the present invention and the converse is equal.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A card payment management system comprising:
a database for registering and storing a cellular phone number of a cellular phone of a card owner or manager;
a card payment terminal for reading information of a card in a contacting state or an accessing state of the card to pay a corresponding payment sum and transmitting the corresponding payment sum, the information of the card, and a payment request; and
a server for receiving the corresponding payment sum, the information of the card, and the payment request from the card payment terminal, recognizing a location of a registered cellular phone on the basis of the information of the card, and performing a payment management sequence according to a predetermined distance of the registered cellular phone apart from the card payment terminal;
the payment management sequence for:
paying the corresponding payment sum if the corresponding payment sum is below a first reference sum;
reporting the payment to the registered cellular phone if the corresponding payment sum is more than the first reference sum and below a second reference sum; and
paying the corresponding payment sum in case of an approval of the payment from the registered cellular phone by requesting a payment approval to the registered cellular phone if the corresponding payment sum is more than the second reference sum.

2. The card payment management system of claim 1, wherein the card comprises at least one of a credit card, a golf membership, a bond, a certificate of deposit, or various stocks.

3. The card payment management system of claim 1, wherein the card payment terminal comprises a mobile terminal or a fixing terminal.

4. A card payment management method comprising the steps of:
registering of the cellular phone number of the cellular phone of the card owner or manager;
registering the card payment terminal;
sensing the contacting state or the accessing state of the card to the card payment terminal to pay the corresponding payment sum;
tracking the location of the registered cellular phone and the location of the card payment terminal when sensing the contacting state or the accessing state of the card;
identifying whether the location of the registered cellular phone and the location of the card payment terminal are apart from each other in a predetermined distance;
performing the payment management sequence according to the corresponding payment sum if the location of the registered cellular phone and the location of the card payment terminal are apart from each other in the predetermined distance; and
paying the corresponding payment sum if the location of the registered cellular phone and the location of the card payment terminal are not apart from each other in the predetermined distance;
the payment management sequence comprising the steps of:
paying the corresponding payment sum if the corresponding payment sum is below the first reference sum;
reporting the payment to the registered cellular phone if the corresponding payment sum is more than the first reference sum and below the second reference sum; and
paying the corresponding payment sum in case of the approval of the payment from the registered cellular phone by requesting the payment approval to the registered cellular phone if the corresponding payment sum is more than the second reference sum.

5. A card payment management method comprising the steps of:
registering of the cellular phone number of the cellular phone of the card owner or manager;
registering the card payment terminal;
sensing the contacting state or the accessing state of the card to the card payment terminal to pay the corresponding payment sum;
tracking the location of the registered cellular phone and the location of the card payment terminal when sensing the contacting state or the accessing state of the card;
determining whether the corresponding payment sum is more than the first reference sum when sensing the contacting state or the accessing state of the card;
paying the corresponding payment sum if the corresponding payment sum is below the first reference sum;
tracking the location of the registered cellular phone and the location of the card payment terminal if the corresponding payment sum is more than the first reference sum;
identifying whether the location of the registered cellular phone and the location of the card payment terminal are apart from each other in the predetermined distance;
paying the corresponding payment sum if the location of the registered cellular phone and the location of the card payment terminal are not apart from each other in the predetermined distance;
determining whether the corresponding payment sum is more than the second reference sum if the location of the registered cellular phone and the location of the card payment terminal are apart from each other in the predetermined distance;
paying the corresponding payment sum if the corresponding payment sum is below the second reference sum and reporting the paid sum to the registered cellular phone; and
requesting the payment approval to the registered cellular phone if the corresponding payment sum is more than the second reference sum and paying the corresponding payment sum according to the payment approval of the registered cellular phone.

6. The card payment management method of claim 4, wherein the step of requesting the payment approval to the registered cellular phone and paying the corresponding payment sum according to the payment approval of the registered cellular phone comprises the step of requesting transmission of a predetermined confirmation number to the registered cellular phone and to pay the corresponding payment sum when transmitting the confirmation number from the registered cellular phone.

7. The card payment management method of claim 4, wherein the card comprises at least one of a credit card, a golf membership, a bond, a certificate of deposit, or various stocks.

8. The card payment management method of claim 4, wherein a change of orders of the step of registering the cellular phone number of the cellular phone of the card owner or manager or the step of registering the card payment terminal does not have an influence on an operating result.

9. A card payment management method comprising the steps of:
performing a login to a card payment server through a wire/wireless communication network;
registering the information of the card to the payment management server;
setting a payment management region of the card according to the corresponding payment sum through the payment management server; and
registering the cellular phone number of the cellular phone of the card owner or manager to the payment management server;
the step of setting the payment management region of the card comprising the step of a small sum payment section for paying directly the corresponding payment sum, a payment reporting section for reporting the payment to the registered cellular phone according to the payment of the corresponding payment sum, and a payment approval request section for requesting the approval of the corresponding payment sum through the registered cellular phone, as a payment management region.

10. The card payment management method of claim 9, wherein the step of setting the payment management region of the card comprises the step of managing the payment of the card according to the corresponding payment sum when the location of the card payment terminal and the location of the registered cellular phone are apart from each other in the predetermined distance father than the reference distance.

11. A card payment management method comprises the steps of:
registering the location of the card payment terminal to a location tracking system;
registering the cellular phone number of the card owner or manager to the location tracking system;
setting an immediate payment section, the payment reporting section, and the payment approval request section to the payment management server according to the corresponding payment sum of the card;
sensing the contacting state or the accessing state of the card when the card comes in contact with the card payment terminal or accesses the card payment terminal;
determining whether the registered cellular phone and the card payment terminal are separated from each other in the distance father than the predetermined distance when sensing the contacting state or the accessing state of the card;
determining whether the corresponding payment sum belongs to a certain section of the immediate payment section, the payment reporting section, or the payment approval request section if the registered cellular phone and the card payment terminal are separated from each other in the distance father than the predetermined distance; and
paying the corresponding payment sum if the corresponding payment sum belongs to the immediate payment section, paying the corresponding payment sum and reporting the paid sum to the registered cellular phone if the corresponding payment sum belongs to the payment reporting section, and requesting the payment approval of the corresponding payment sum to the registered cellular phone if the corresponding payment sum belongs to the payment approval request section.

12. The card payment management method of claim 11, wherein the step of setting the immediate payment section, the payment reporting section, and the payment approval request section according to the corresponding payment sum of the card comprises the steps of setting the immediate payment section when the corresponding payment sum is below the first reference sum, setting the payment reporting section when the corresponding payment sum is more than the first reference sum and below the second reference sum, and setting the payment approval request section when the corresponding payment sum is more than the second reference sum.

13. The card payment management method of claim 11, wherein the step of requesting the payment approval of the corresponding payment sum to the registered cellular phone if the corresponding payment sum belongs to the payment approval request section comprises the step of paying the corresponding payment sum when receiving the approval of the payment from the registered cellular phone.

14. The card payment management method of claim 11, wherein the card comprises one of the credit card and a card mounted in a second cellular phone in order to perform a payment function.

15. A card payment management method comprising the steps of:
performing the login to an internet banking server;
inputting withdrawal account information and deposit account information related to the transfer or payment information and the corresponding payment sum to the internet banking server;
determining an additional transfer or payment;
transmitting an approval request of the transfer or the payment to a cellular phone or an E-mail of a payer or a transferring person;
receiving a confirmation number through the cellular phone or the E-mail from the prayer or the transferring person;
confirming whether the confirmation number is a valid confirmation number with respect to the payment or the approval; and
paying the corresponding payment sum if the confirmation number is correct.

16. The card payment management method of claim 15, wherein the step of inducing the transferring person and the payer further comprises the steps of:
tracking a first location corresponding to deposit account information for the transfer or a second location of the card payment terminal corresponding to the payment information;
tracking a third location of the cellular phone of the payer or the transferring person; and
inducing the transferring person or the payer to perform the login to the internet banking server if the first location or the second location is separated from the third location in the distance father than the predetermined distance D.

17. A card payment management method comprising the steps of:
downloading the VM module by accessing the VM module having a payment system function to a financial institution system;
storing and initializing the downloaded VM module to the cellular phone and registering the cellular phone as a payment unit to a financial institution server;
performing an input to use selectively at least one or all of the credit card, the debit card or a mileage card of the cellular phone owner by connecting at least one or all of the credit card, the debit card or the mileage card to the downloaded VM module and transmitting information of at least one or all of the credit card, the debit card or the mileage card to the financial institution server; and
inputting authentication information for authenticating at least one or all of the credit card, the debit card or the mileage card through VM module and setting the authentication information by transmitting the authentication information to the financial institution server.

18. A card payment management method comprising the steps of:
downloading a payment request system file from the financial institution server to a terminal of a payment demander—the terminal comprising a cellular phone or a computer of the payment demander—;
installing the downloaded payment request system file to the terminal and registering the terminal as a payment request system to the financial institution sever;
inputting a corresponding payment sum and a payment specification to the terminal, and transmitting the inputted corresponding payment sum, the payment specification, and the payment request to the cellular phone of the payer or the E-mail of the payer;
the payer transmitting an authentication number to the financial institution server through the cellular phone or the E-mail if the corresponding payment sum, the payment specification, and payment demander information received through the cellular phone or the E-mail is confirmed; and
the financial institution server paying the corresponding payment sum if the authentication number is correct;
the step of transmitting the authentication number to the financial institution server comprising the step of transmitting additionally the state of the installment payment of the corresponding payment sum and installment months as well as the authentication number.

19. The card payment management method of claim 18, wherein
the terminal transmits the inputted corresponding payment sum, the payment specification, and the payment request to the financial institution server, the financial institution server tracks the location of the terminal, the financial institution server tracks the location of the cellular phone of the payer, the financial institution server pays immediately the corresponding payment sum without receiving the authentication number if the location of the terminal and the location of the cellular phone are within the reference distance, and the financial institution server transmits the corresponding payment sum, the payment specification, the payment demander information, and the payment request of the corresponding payment sum to the cellular phone if the location of the terminal and the location of the cellular phone are separated from each other in the distance father than the reference distance.

20. The card payment management method of claim 19, wherein the step of transmitting the payment request of the corresponding payment sum comprises the steps of:
paying immediately the corresponding payment sum if the corresponding payment sum is below the first reference sum;
paying the corresponding payment sum if the corresponding payment sum is more than the first reference sum and below the second reference sum and reporting the payment to the cellular phone; and
transmitting the payment request of the corresponding payment sum to the cellular phone if the corresponding payment sum is more than the second reference sum.

21. The card payment management method of claim 18, comprising the steps of:
downloading a VM banking payment unction module to the cellular phone;
registering the VM banking payment function module of the cellular phone to the financial institution server by connecting the VM banking payment function module to the card; and
registering the authentication number to pay or approve the card.

22. The card payment management method of claim 21, wherein the payment demander—the payment demander comprising at least one of a utility bill receiver, a cashier, and a delivery registered to the financial institution server—transmits the payment specification and the corresponding payment sum by inputting the cellular phone number of the payer.

23. A card payment management method comprising the steps of:
inputting the cellular phone number of the payer into a payment information input window of the terminal of the payment demander—the terminal of the payment demander comprising the cellular phone, a number input unit, the card terminal or the computer—;
inputting the corresponding payment sum and the payment specification into the payment information input window of the terminal of the payment demander;
the terminal of the payment demander transmitting the corresponding payment sum and the payment specification to the cellular phone of the payer;
the cellular phone of the payer receiving the corresponding payment sum, the payment specification, the information of the payment demander, and the approval request of the corresponding payment sum;
the cellular phone of the payer displaying the corresponding payment sum, the payment specification, and the information of the payment demander and providing a confirmation number input menu for the corresponding payment sum;
the cellular phone of the payer transmitting the number inputted into the confirmation number input menu as the authentication number to the financial institution server; and
the financial institution server paying the corresponding payment sum if the authentication number is correct or transmitting a reentering request to the cellular phone of the payer if the authentication number is not correct;
the step of transmitting the reentering request to the cellular phone of the payer comprising the step of finishing the payment process if the reentering number of the authentication number exceeds the predetermined number.

24. The card payment management method of claim 23, the payment demander, as an employee of a same enterprise agent includes a delivery man, a taxi driver, or a counter and the step of providing the confirmation number input menu for the corresponding payment sum provides a payment mean selection menu when one of the credit card, the debit card, and the mileage can be selected as a payment mean.

25. A card payment management method comprises the steps of:
displaying a payment input window of the cellular phone of the payer;
inputting an ID number of the payment demander into the payment input window;
accessing the payment system of the payment demander through the communication network by using the ID number of the payment demander;
the payment system transmitting a payment specification list of the payer, the cellular phone of the payer displaying the payment specification list of the payer on the payment input window;
selecting a corresponding payment specification of the payment specification list of the payer and transmitting the corresponding payment sum and a payment confirmation number by inputting the corresponding payment sum and the payment confirmation number into the payment input window; and
the payment system paying the corresponding payment sum with respect to the corresponding payment specification if the payment confirmation number is correct;
the step of selecting the corresponding payment specification of the payment specification list of the payer includes the step of searching the corresponding payment specification of the payment specification list by using a name, a membership number, or a client number of the payer.

26. The card payment management method of claim 25, wherein the ID number of the payment demander is displayed on a utility bill or a TV home shopping screen and the ID number of the payment demander is a card payment terminal number or the cellular phone number of the payment demander;
the step of transmitting the corresponding payment sum and the payment confirmation number to the payment system by inputting the corresponding payment sum and the payment confirmation number into the payment input window being performed by a selection menu capable of selecting an installment payment with respect to the corresponding payment specification or inputting a part of the total corresponding payment sum as a present corresponding payment sum.

27. A card payment management method comprising the steps of:
downloading a VM banking module having a card payment function;
the card owner or manager performing an authentication process through the VM banking module;
the card owner or manager setting a limit and an expiration date of the card through the VM banking module;
registering the cellular phone number of the card owner or manager and the limit and the expiration date of the card through the VM banking module to the server;
performing a connection process to the server through the VM banking module to pay the corresponding payment sum;
the server determining whether the corresponding payment sum is more than or less than the limit and determining whether the present date exceeds the expiration date;
the server transmitting a confirmation number input request to the cellular phone having the VM banking module if the corresponding payment sum is less than the limit and the present date does not exceed the expiration date;
inputting the confirmation number for paying the corresponding payment sum through the VM banking module;
the server determining whether the confirmation number is correct or not; and
the server paying the corresponding payment sum if the confirmation number is correct.

28. A card payment management method comprising the steps of:
the payment demander including the utility bill receiving part or an apartment maintenance performing a registration process to use the payment system of the financial institution including the bank or the card company;
registering the cellular phone of the payer having the payment function to the payment system of the financial institution;
accessing the payment system of the financial institution through the cellular phone of the payer;
the payment system of the financial institution transmitting the ID number of the payment demander, the information of the payment demander, and the corresponding payment sum to the cellular phone of the payer;
selecting the corresponding payment specification by searching the information of the payment demander and the corresponding payment sum through the cellular phone of the payer;
selecting one of the credit card, the debit card, or the mileage card as the payment mean for the corresponding payment specification or confirming a predetermined payment mean if the payment mean is not selected;
inputting the authentication number into the cellular phone of the payer and transmitting the inputted authentication number to the payment system; and
the payment system paying the corresponding payment sum corresponding to the corresponding payment specification if the authentication number is correct.

29. A card payment management method comprising the steps of:
the payment demander including the utility bill receiving part or the apartment maintenance performing the registration process to use the payment system of the financial institution including the bank or the card company;
registering an ID or an internet IP address of the payer having the payment function to the payment system of the financial institution;
accessing the payment system of the financial institution through the internet by using a terminal of the payer;
the payment system of the financial institution transmitting the ID number of the payment demander and the information and the corresponding payment sum of the payment demander to the terminal of the payer;
selecting the corresponding payment specification by searching the information and the corresponding payment sum of the payment demander through the terminal of the payer;
selecting one of the credit card, the debit card, or the mileage card as the payment mean for the corresponding payment specification or confirming the predetermined payment mean if the payment mean is not selected;
inputting the authentication number into the terminal of the payer and transmitting the authentication number to the payment system; and
the payment system paying the corresponding payment sum corresponding to the corresponding payment specification if the authentication number is correct.

30. A card payment management method comprising the steps of:
to downloading and storing the VM banking module having the payment function and an internet access function into the cellular phone of the payer;
accessing the internet through the VM banking module;
searching and selecting a purchasing product through the VM banking module;
selecting the payment for the selected product of the payer through the VM banking module;
authenticating the purchaser information of the payer through the VM banking module;
selecting one of the credit card, the debit card or the mileage card as the payment mean if the authentication process is performed successfully or confirming the predetermined payment mean if the payment mean is not selected;
determining whether the corresponding payment sum is within the limit set in the VM banking module;
inputting the payment confirmation number for the corresponding payment sum through the VM banking module; and
paying the corresponding payment sum if the confirmation number is correct.

31. A card payment management method comprising the steps of:
downloading and storing the VM banking module having the payment function and an internet access function into the cellular phone of the payer;
accessing the internet through the VM banking module;
searching and selecting a purchasing product through the UM banking module;
transmitting the cellular phone number of the payer through the VM banking module;
the payment demander transmitting the corresponding payment sum, the information of the payment demander, and a transaction to the cellular phone of the payer and requesting an input of the confirmation number for the corresponding payment sum to the cellular phone of the payer;
inputting and transmitting the confirmation number through the VM banking module; and
the payment demander paying the corresponding payment sum if the confirmation number is correct.

32. A card payment method for paying for Internet, TV shopping, games, tickets, characters, and so on by a credit card, a debit card or a mileage card stored in a cellular phone, the card payment method comprising the steps of:
registering information on the credit card, debit card or mileage card within the cellular phone;
coming payment page out after choosing and searching in order to buying goods or usufruct on Internet or TV shopping, games, tickets, characters, and so on within the cellular phone;
showing the next payment page or the payment page with major information on the credit card, debit card or mileage card within the cellular phone coming payment page out;
inputting an authentication number and so on in order to pay after choosing the card type and installment;
transferring into a card company, a bank or a mileage company if correct putting the card password number and authentication number on within the cellular phone; and
paying if verified the card in the card company, bank or mileage company.

33. The card payment management method of claim 5, wherein the step of requesting the payment approval to the registered cellular phone and paying the corresponding payment sum according to the payment approval of the registered cellular phone comprises the step of requesting transmission of a predetermined confirmation number to the registered cellular phone and to pay the corresponding payment sum when transmitting the confirmation number from the registered cellular phone.

34. The card payment management method of claim 5, wherein the card comprises at least one of a credit card, a golf membership, a bond, a certificate of deposit, or various stocks.

35. The card payment management method of claim 5, wherein a change of orders of the step of registering the cellular phone number of the cellular phone of the card owner or manager or the step of registering the card payment terminal does not have an influence on an operating result.
